(19) United States
(12) Patent Application Publication
(10) Pub. No.: US 2007/0224969 A1
(43) Pub. Date: Sep. 27, 2007

(54) Prepaid simcard for automatically enabling services

(76) Inventor: Bindu Rama Rao, Laguna Niguel, CA (US)

Correspondence Address: Bindu Rama Rao, 21 Henley Drive, Laguna Niguel, CA, 92677, US

(21) Appl. No.: 11/388,865

(22) Filed: Mar. 24, 2006

(51) Int. Cl. H04M 1/66

(52) U.S. Cl. 455/411

(57) ABSTRACT

A mobile network wherein a mobile device with a prepaid SIM/Smart card is able to access services made available by a provider or operator providing the prepaid card, wherein the prepaid card not only provides the user's authorization to use the network, but also a default email account that can be used to at least send email, including pictures taken, and a default website account that can be used to at least upload pictures. A user of a mobile device can use a prepaid SIM card to access one or more specific services made available by the prepaid SIM card, the one or more specific services comprising a gaming service, an email service and a broadcast service.

### RELATED APPLICATIONS

The present application makes reference to, is a continuation of, and claims benefit of U.S. Provisional Patent Application, Attorney Docket Number BRR2005US05, entitled “PREPAID SIMCARD FOR AUTOMATICALLY ENABLING SERVICES”, filed on Mar. 25, 2005, the complete subject matter of which is hereby incorporated herein by reference, in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Electronic devices, such as mobile phones and personal digital assistants (PDA's), often contain small screens with very limited viewing area. They are constrained in terms of how much information can be displayed, and in terms of user interaction capabilities. The keyboards on cell phones, for example, are not conducive for user data entry, and only brief user inputs can be solicited from a user without annoying the user.

Typically, a SIM (Subscriber Identification Module or Subscriber Identity Module) card—a.k.a. “smart card”—holds all of a subscriber's personal information and phone settings. In essence, it is the subscriber's authorization to use the network. It also holds the phone number, personal security key and other data necessary for the handset to function. The card can be switched from phone to phone, letting the new phone receive all calls to the subscriber's number. Prepaid SIM cards are quite popular in some countries. Unfortunately, in the case of prepaid cards, the user does not have access to no services that he would otherwise have if he had a regular subscription based SIM/Smart card. Prepaid cards have a mechanism to deduct call charges from the prepaid amount, or from the current balance of a prepaid amount. Prepaid SIM cards are a convenient service wherein a user can get access to mobile phone service without having to sign up for long term (such as a 2 year) contracts.

Prepaid cards are fairly limited in what they let a user access in an operator's network. For example, a user has make mobile calls, receive mobile calls, send SMS messages and receive SMS messages. Only a few prepaid mobile cards provide voicemail access. Unfortunately, in the case of prepaid cards, the user typically does not have access to no services that he would otherwise have if he had a regular subscription based SIM/Smart card.

Some companies use promotional cards that provide access to long distance phone services. Promotional cards are prepaid long distance phone cards for any business to give away to employees, customers and prospects. The card recipients get free minutes (you choose the amount or denomination) and can call anywhere, for example anywhere in North America. However, such promotional cards do not provide access to data services. In fact, a user using such promotional cards have access only to voice connections, and often have no voice mail support either.

Further limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

A method and/or system for a mobile handset network to employ compression and decompression mechanisms in order to update firmware and software in mobile handsets that might be partially or totally compressed, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

The numerous objects and advantages of the present invention may be better understood by those skilled in the art by reference to the accompanying figures in which:

FIG. 1 is a perspective diagram of a mobile network wherein a mobile device with a prepaid SIM/Smart card is able to access services made available by a provider or operator providing the prepaid card, wherein the prepaid card not only provides the user's authorization to use the network, but also a default email account that can be used to at least send email, including pictures taken, and a default website account that can be used to at least upload pictures.

FIG. 2 is a perspective block diagram of a network that permits a mobile device with a prepaid SIM/Smart card to access one or more services, such as a email service and to upload pictures taken by a camera in the mobile device to a storage, for subsequent retrieval.

FIG. 3 is a perspective block diagram of a network wherein a user of a mobile device can use a prepaid SIM card to access one or more specific services made available by the prepaid SIM card, the one or more specific services comprising a gaming service, an email service and a broadcast service.

### DETAILED DESCRIPTION OF THE INVENTION

Aspects of the present invention relate generally to the update of mobile devices that contain firmware and software, wherein at least some of the firmware and software may be stored in a compressed form. The following discussion makes reference to the term “electronic device” that is used herein to refer to mobile electronic devices such as, for example, a mobile handset, a cellular phone, a personal digital assistant (PDA), a pager, and a personal computer, to name just a few. Although the listed example electronic devices are mobile devices, application of the present invention is not limited in this manner, as representative embodiments of the present invention may be employed in a wide variety of electronic devices, both fixed and mobile. The following discussion makes reference to the term “Linux” that is used herein to refer to open source UNIX based operating systems, especially those employed in mobile devices. The following discussion also makes reference to the term “network” that is used herein to refer to networks such as, for example, an operator network, an enterprise network, an Internet based network, a management network for a service, etc.

Electronic devices may be adapted to access servers to retrieve update information for updating memory in the electronic devices. An electronic device may be, for example, a mobile electronic device having firmware/software such as mobile cellular phone handsets, personal digital assistants (PDAs), pagers, MP-3 players, digital cameras, to name just a few. Update information may comprise information that modifies or changes firmware/software and/or software components installed in the electronic device. In a representative embodiment of the present invention, update information may comprise a set of executable instructions for converting a first version of code to an updated/second version of code. The update information may add new services to the electronic device, as desired by a service provider, device manufacturer, or an end-user, and/or may fix bugs (e.g., errors) in the operating code of the electronic device. In a representative embodiment of the present invention, update information may comprise an update package.

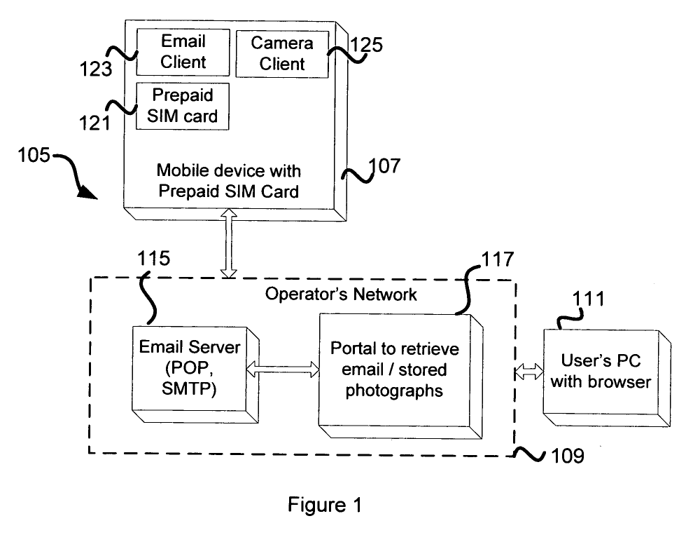

FIG. 1 is a perspective diagram of a mobile network 105 wherein a mobile device 107 with a prepaid SIM/Smart card 121 is able to access services made available by a provider or operator providing the prepaid card, wherein the prepaid card not only provides the user's authorization to use the network 105, but also a default email account that can be used to at least send email, including pictures taken, and a default website account that can be used to at least upload pictures.

The network 105 comprises the mobile device with prepaid SIM/Smart card 107, an operator's network 117, and a user's PC with browser 111 that a user employs to access emails sent to or from the mobile device 107, and pictures uploaded to a portal 117 from the mobile device 107. The operator's network 109 comprises a email server 115 that provides access to an incoming email service, such as POP3 or IMAIL, and a sending email service, such as SMTP service. The operator's network 109 also comprises a portal 117 where pictures, email and other information communicated to the operator's network 109 from the mobile device 107 can be viewed or retrieved, such as by using the user's PC with browser 111.

The prepaid SIM (Subscriber Identification Module or Subscriber Identity Module)/Smart card 121 holds all of a user's subscription information, phone settings and email settings for a default email account for the prepaid card user that the user can use to receive and send emails, or at least to forward email to the user's default email server, that is perhaps outside the operator's network 109. Using the SMTP server component of the email server 115 provisioned by the email settings, the mobile device can send emails, pictures taken by the camera, etc.

The mobile device 107 comprises the prepaid SIM/Smart card 121, an email client 123 that facilitates sending and receiving emails, sending and receiving pictures, etc. and a camera client 125 that facilitates taking pictures using a camera inbuilt in the mobile device 107 (or plugged into the mobile device 107), storing the picture in a non-volatile memory of the mobile device 107, or uploading the pictures into a portal 117 in the operator's network 109.

Using a website account for the portal 117, provisioned by the prepaid SIM card 121, the mobile device 107 can upload pictures taken by the user using the camera and the camera client 125 in the mobile device 107, to the web site/portal 117 designated as a place where pictures may be uploaded. Access to the website address is provisioned into the mobile device 107 using a connectivity settings (that includes a network access point) provided by the prepaid SIM card 121.

In essence, the prepaid SIM card 121 not only provides the subscriber's authorization to use the operator's network 117, but also a default email account that can be used to at least send email, including pictures taken, and a default portal/website 117 account that can be used to at least upload pictures. In addition, as typical, the prepaid card also holds the phone number, personal security key and other data necessary for the handset to function.

The prepaid SIM/Smart card 121 can be switched from phone to phone, letting the new phone receive all calls to the subscriber's number and still have access to the default email account and website for picture uploads. Prepaid cards, such as prepaid SIM card 121, have a mechanism to deduct call charges from the prepaid amount, or from the current balance of a prepaid amount. Thus, charges for email and picture uploads are selectively deducted when a user employs those services enabled by the prepaid SIM/Smart card 121.

When the prepaid SIM card 121 is introduced into the mobile device 107 for the first time, the mobile device prompts the user to configure the device with an email service 115, i.e. for an incoming email server, such as a POP server, and an outgoing email server, such as an SMTP server, using configuration information provided by an operator (or some provisioning entity) in the prepaid SIM card 121. For example, the SIM card 121 provides a default POP and SMTP server configurations in a bootstrap file located in the SIM card 121 which the mobile device 107 is capable of detecting and reading. In addition, a default user email account is configured from bootstrap information in the SIM card 121. For example, the default user email account has a unique user identification and an associated password that can be used in conjunction with an account on the POP server and an SMTP server provided by the email server 115.

Thus, the network 105 provides “contract free”, “commitment free” prepaid cellular services where a user has “pay as you go” convenience. The prepaid cellular service in the network 105 lets a user to stay connected without any monthly, contractual obligations therefore allowing more flexibility regarding when the user will use his mobile handset. The network 105 also prevents over-usage for user's of the prepaid SIM card 121 and therefore the prepaid service provided is more “worry free” than subscription service.

For user's who are foreigners visiting a foreign network/market where the network 105 service is available,—whether they intend to stay for one week or six months, the prepaid SIM card 121 is a means for accessing services that the user's might need without having to subscribe to a long-term service.

The network 105 facilitates recharge of SIM/Smart cards—such rechargeable cards may also be referred to locally as top up cards or refill cards. They can be purchased at local retail stores, such as local Tabac shops, convenience stores and authorized dealers of the network 105.

In order to recharge the SIM/Smart card 121 (typical of most recharge cards), a user will scratch off the gray protective strip on a recharge voucher (also called an airtime voucher or a recharge card), which is often a thin card made from plastic or paper, to reveal a reload code on a SIM/Smart Card recharge voucher. Once the reload code has been revealed, the user simply follows the instructions to add the airtime on the recharge card, to the prepaid SIM card. The user is usually directed to dial a number on the mobile handset (such as a GSM cell phone) and prompted to enter in a reload code. Thus, one mechanism for adding airtime to your prepaid SIM/Smart Card 121, and thus continuing the use of the default email account, the website to upload pictures, etc. is the reload code. The reload code is usually 12-16 digits and is purchased through an airtime voucher, usually when the current balance of airtime on the prepaid SIM/Smart card 121 is depleted and the access to the prepaid service by the user is likely to end soon. The airtime voucher typically has a denominational value printed on one side and a grayed over section which must be rubbed away to reveal your reload code (also called voucher code), on the other side.

Recharging the SIM/Smart card 121 before the expiry period of the prepaid SIM/Smart card 121 enables the continuation of previously assigned default email account, website account, etc. In one embodiment, these accounts are retained for a period (such as two months) beyond the expiry period of the SIM/Smart card 121 in order to give the user an opportunity to continue access/usage of the associated services provided.

Use of ‘Voucher Card’ to recharge the value in a user's prepaid account is a traditional and yet expensive solution as the associated support activities include printing, stocking, handling and shipping of hard scratch cards, not to mention tracking and reporting of costs. Alternatively, some operators have introduced top-up via ATM machines or the internet. This solution improves the accessibility of the user to recharge the user's prepaid accounts; however, it still does not provide the ultimate convenience for subscribers to top-up their prepaid account anytime and anywhere. Wireless means that are secure are also provided for topping up the prepaid SIM cards.

In general, the mobile device 107 is capable of communicating with a wireless network 109 using an authentication card 121. The mobile device comprises the authentication card, which is a pre-paid authentication card such as a prepaid SIM card, one that a user typically acquires by purchasing from a dealer. The mobile device is capable of being used for voice communication over the wireless network 109 with a second mobile device using a voice communication authentication information provided by the pre-paid authentication card 121. In general, a client application on the mobile device 107 can be executed on the mobile device. The client application accesses a service using a configuration information provided by the pre-paid authentication card 121.

The mobile device 107 uses the pre-paid authentication card 121 for authenticating voice services as well as data services, such as an email service. The pre-paid authentication card 121 is typically one of the following—a SIM card, a SmartCard, a USIM Card and a WIM card. In one embodiment, the client application is an email client application 123 and the service is an email service. The pre-paid authentication card 121 provides an email user account information and an associated email account password information for use by the email client application 123 to access the email service. Configuration information provided by the pre-paid authentication card comprises an incoming email server access information, such as a POP3 or IMAIL server access, and an outgoing mail server access information, such as an SMTP server access information.

In general, the mobile device 107 uses a pre-paid authentication card 121 which is one of a SIM card, a SmartCard, a USIM Card and a WIM card, as appropriate, and as compatible with the mobile device 107. The prepaid authentication card 121 provides a client security information to the client application enabling access to the service via the client application. In a related embodiment, the service is a data service in the wireless network 109 that can be accessed by a user of the mobile device 107 using the client application, such as the email client 123 and the camera client 125. The mobile device 107, in one embodiment, comprises a camera client application 125 that can be used to take a picture that also is capable of using a data service such as a communication service employed by the camera application to upload the picture to a website or portal 117 communicatively coupled to the mobile device 107.

In one embodiment, the prepaid authentication card 121 makes it possible for a customer to get a fixed number of emails and a fixed number of picture uploads to a portal or website—for example, 1000 emails and 100 picture updates. It may also provide the customer access to unlimited SMS service. In a related embodiment, it provides the user with a default email account for the email service and a default website for uploading (and subsequently accessing over the Internet) the pictures taken by the user using the mobile device.

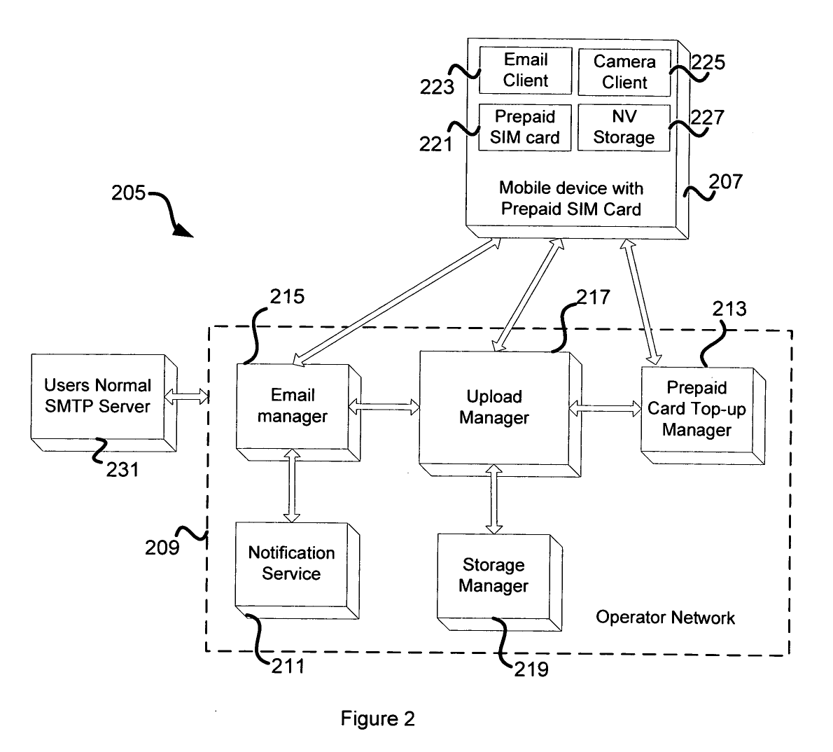

FIG. 2 is a perspective block diagram of a network 205 that permits a mobile device 207 with a prepaid SIM/Smart card 221 to access one or more services, such as a email service and to upload pictures taken by a camera in the mobile device 207 to a storage, for subsequent retrieval. The mobile device 207 comprises the prepaid SIM/Smart card 221 that can be recharged using recharge voucher's or an online recharge service, an email client 223 that can send email and pictures and receive email, a camera client that can be used to store, retrieve and upload pictures taken by a camera built into the mobile device 207 or plugged into the mobile device 207, and a non-volatile (NV) storage 227 that is used to store email, pictures, etc.

The network 205 comprises the mobile device 207, an operator's network 209 and an user's normal SMTP server 231 that is used to send email by a user, such as while using a PC or a computer system. The operator's network 209 comprises a prepaid card top-up manager 213 that can be used by the user to top-up or recharge the balance on the prepaid SIM/Smart card 221 using the mobile device 207 or a PC capable of interacting with the prepaid card top-up manager 213. It also comprises an upload manager that is used by the camera client 225 of the mobile device 207 to upload pictures to a storage 219, the storage 219 that is used by the operator network 209 to store pictures uploaded by users and other data, an email manager 215 that is used to send and receive email from and to the mobile device 207, respectively, and a notification service 211 that is used by the operator network 209 to notify the user of the mobile device 207 on balance amount left on the service made accessible by the prepaid SIM/Smart card 221. The notification service 211 is also used by the operator's network 209 to inform the mobile device on pictures uploaded, the imminent termination of service, the depletion of balance on the prepaid SIM/Smart card 221, etc.

The wireless prepaid recharge solution provided by the prepaid card top-up manager 213 comprises the prepaid SIM Card 221 with at least one secure channel application and a transaction manager in the prepaid card top-up manager 213 which acts as a mediating platform to allow a prepaid account recharge via different payment methods. The transaction manager is a standard payment gateway which is capable of interacting with several payment solution providers. The prepaid SIM Card 221 allows for a menu-driven and secure user interface, ideal for functioning as a device for mobile payment. A mobile reload application that resides on the prepaid SIM Card 221 allows the subscriber to securely store payment information, such as credit card numbers or bank account information, and use this to reload his prepaid account within seconds.

In one embodiment, a top-up application is embedded in the prepaid SIM Card 221. Using a SIM Application toolkit Technology in the prepaid SIM Card 221, which is a standard interface to a SIM card, the top-up application provides a step-by-step approach to guide the subscribers to complete the prepaid top-up process. In addition, it also allows the subscribers to customize their ‘designated threshold’. A recharge reminder or auto-recharge function is triggered once the ‘designated threshold’ point is reached.

In one embodiment, the operator networks 209 terminates the SIM number and unused time if a user does not charge the card within a certain time limit. In this case, the default email account and the website for uploading pictures are retained for a certain duration subsequent to termination of the prepaid SIM Card 221, giving the user an option to recharge, or at least pay for the continued use of the email account and the website for uploading pictures.

Generally, for user's of the prepaid SIM/Smart Card 221, calls are charged by the minute or fraction thereof, depending on the country. In the case of email that is sent, or pictures uploaded, the charges are based on the size of the email or the size of the pictures. In one embodiment, a flat rate is employed for email charges and pictures uploaded.

In one embodiment, the prepaid SIM Card 221 works while roaming outside of the country of origin, as will sometimes be the case, the emails sent and pictures uploaded, as also outgoing calls will cost more than normal.

Although the figures are described in terms of SIM cards, it must be understood that the SIM card is used to generically refer to SIM, USIM, RIM, WIM, Smart Cards, Contact-less cards and other similar removable devices that are employed by mobile devices for identification and security.

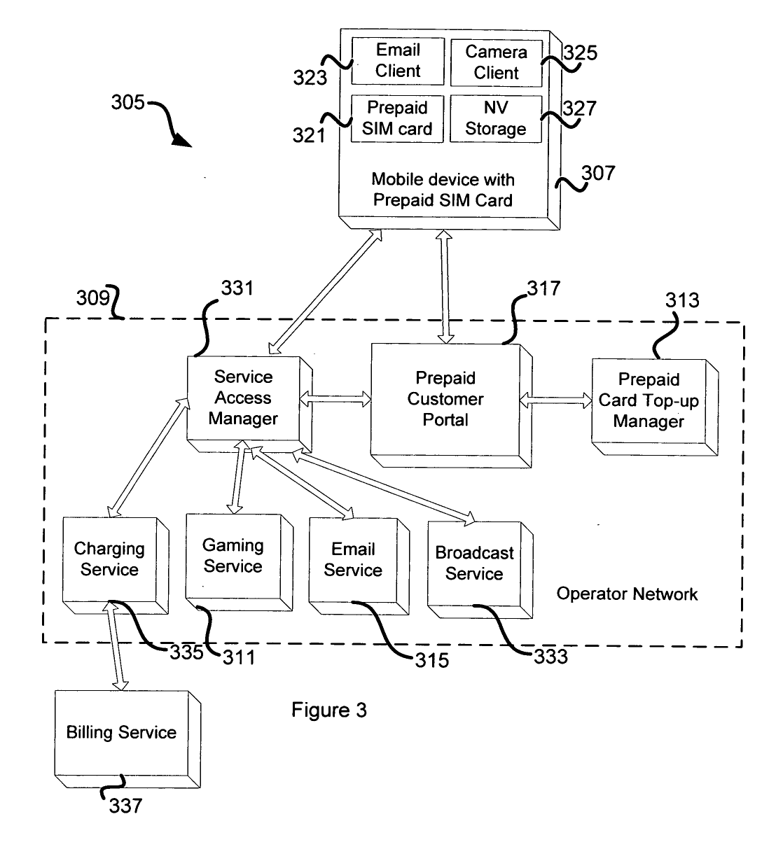

FIG. 3 is a perspective block diagram of a network 305 wherein a user of a mobile device 307 can use a prepaid SIM card 321 to access one or more specific services made available by the prepaid SIM card 321, the one or more specific services comprising a gaming service 311, an email service 315 and a broadcast service 333.

A prepaid SIM/Smart card 321 for email service is used to provide access only to an email service 315 (user being able to select a flat rate for email or charges based on number of kilobytes of email sent/received). Thus, the user is restricted to just the email service 315, and not even to a phone service by such a prepaid SIM/Smart card 321.

Over-the-air service enablement for prepaid SIM/Smart cards 321, wherein a user can select specific services (one or more) for the prepaid SIM/Smart card 321, and enable those services, such as during a wireless top-up activity, is supported. Thus, a generic prepaid card 321 can be made into a service specific prepaid card 321 by an authorized user, thereby expanding or restricting access to services accessed by a user. In addition, a website/portal (not shown) is used by a user to select such services for enablement on a prepaid SIM/smart card. Alternatively, the mobile device 307 itself is used by the user to select such services for enablement on a device 307 where the prepaid SIM/smart card 321 is employed.

A user uses the prepaid customer portal 317 to set up services that the user intends to access via the prepaid SIM card 321 with the help of a service access manager communicatively coupled to the prepaid customer portal 317, top-up the balance on the prepaid SIM/Smart card 321 with the help of a prepaid card top-up manager 313 that is communicatively coupled to the prepaid customer portal 317, and check on the available balance on the prepaid SIM card 321.

The user can initially set up access to one or more services using the prepaid customer portal 317, either using the mobile device 307 or a user's PC (not shown). Subsequently, the user of the mobile device 307 can access one or more services, such as the gaming service 311, by interacting with the service access manager 331 that manages user access to one or more services made available by the operator's network. The service access manager 331 makes charge detail records (CDR), created at the end of user's access to specific services, available to an external billing service 337 to facilitate billing.

In one embodiment, the prepaid SIM/Smart card 321 is a promotional prepaid card 321 that provides access to a specific service to a user using the prepaid SIM card 321. For example, a one-half hour access to a gaming network, a one-hour of access to broadcast TV, a promotional offer for 10 free emails, an offer for 20 free picture uploads, etc., or a combination thereof.

The prepaid SIM/Smart card 321 is used to activate and access a gaming service 311 provided by an associated operator network 309, for activating reception of a broadcast TV service 333 provided by a TV station in collaboration with the associated operator network 309, etc.

In one embodiment, the mobile device 307 is a gaming device, such as a game boy, a game cube or an XBOX system, and a prepaid SIM/Smart card 321 is plugged into a gaming device, to provide airtime for the user, for playing a video game or viewing a movie that is streamed to the user's mobile device 307. The prepaid SIM/Smart card 321 is used to selectively provide access to one or more specific services provided by the operator network 309, or by a service provider associated with the operator's network 309 for the gaming service 311, the email service 315 or the broadcast service 333. For example, a prepaid card for the gaming service 311 is used to provide access only to the gaming service 311, that supports interactive games that a user's intends to play (one or more video games). Thus, a parent who would like his child to only play games, and not have access to the browsing on the Internet, or to phone calls, can restrict access to the designated game/service, and not to others. For example, the prepaid SIM/Smart card 321 for a gaming service is used to provide access only to a gaming service 321 (one or more video games), or even to specific gaming service providers (age restrictions for games are enforced). In addition, in one related embodiment, status information of games currently being played by the user is saved in the Prepaid SIM Card 321.

In one embodiment, the mobile device 37 has a client application that is a DVB-H client application that can be used to receive a digital multimedia stream and display it and wherein the data service accessed y the mobile device 307 is a DVB-H based multimedia distribution service. The mobile device is configured to receive DVB-H movies and multi-media data from a DVB-H server that is part of the DVB-H based multimedia distribution service. Such a service may be provided by a

In one embodiment, the mobile device of 307 also works on a wireless network 309 that is a WLAN network. In another embodiment, the mobile device 307 is used in a wireless network 309 that is an interworking combination of a cellular mobile network and a WLAN network, providing access to services provided by a typically cellular mobile network, such as a 3GPP based 3G network while also providing access to services provided by a WLAN network, such as those accessible directly over the Internet.

In general, the mobile device 307 employs the pre-paid authentication card 321 that holds at least one of a user's subscription information, mobile device settings and an email settings for a default email account. In particular, the user can use the default email account provided by the pre-paid authentication card 321 to receive and send emails, such as using a default POP3 server and a default SMTP server for the network 309.

In general, the pre-paid authentication card 321 of the mobile device 307 comprises a mechanism to deduct charges from an associated prepaid amount for the use of data services that a user accesses. The data service that may be charged using the associated prepaid amount or an account balance on the pre-paid authentication card 321 is typically at least one of an email service, an audio download service, a video download service, a streaming media service, a picture upload service, an access to a portal, a push-to-talk service, a VOIP service, an instant messaging service, a game service and an SMS service. The pre-paid authentication card can be recharged and wherein the recharging of the pre-paid authentication card, such as before an expiry event associated with the pre-paid authentication card enables the continuation of the data service. The expiry event can be the expiry date (based on a duration such as a 90 day period), a total count of a data service (such as 100 emails), etc.

In general, the prepaid customer portal 317 is used by a customer to top-up a prepaid card 321 that can be used in the mobile device 307 for accessing voice and data services. The prepaid customer portal 317 facilitates remote access by the customer to setup access to one or more of the data services using the prepaid card wherein the customer accesses the portal employing one of the mobile device 307 or a personal computer via the Internet. The prepaid customer portal comprises user screens that can be used by the customer to setup access to data services that the user intends to access via the mobile device using the prepaid card. In one embodiment, it also comprises a prepaid card top-up manager 313 that provides information on an available balance on the prepaid card and the services access manager 331 that facilitates access of data services associated. The prepaid card top-up manager 313 facilitates the recharging of the prepaid card 321 by the customer using the customer's credit card information, etc.

In one embodiment, the customer can setup services to be accessed using the portal 31 7. A service accesses information associated with the services setup by the customer using the portal 317 is then communicated to the mobile device over-the-air and saved in the prepaid card. Other means of communicating the service access information to the prepaid card 321 are also contemplated, such as the use of a prepaid card management server that manages the prepaid card 321 over a specific management protocol.

In one embodiment, a prepaid access card 321 is used for accessing voice services comprising and data services. The prepaid access card 321 comprises access information for at least one data service that can be accessed by the mobile device 307 with which the prepaid access card 321 is communicatively coupled (by insertion or by being in contact, or by other alternate means). The prepaid access card 321 also has an associated account balance that can be deducted when the data service is accessed via the mobile device307. The account balance is recharged by an over-the-air recharge operation that is performed with the help of the prepaid customer portal 317 or the prepaid card top-up manager 313. The prepaid access card 321 makes it possible to access at least one data service using the mobile device 307 over at least one of a cellular wireless network, a WLAN network, a WiMAX network and an UWB network. For example, it can make it possible for a customer to access voice services from the network 317 while also providing for 100 music downloads from an interworking WLAN network which provides access to a music download service.

In general, in addition to an expiration date, customer identification, security and network access parameters, the prepaid card 321 is capable of providing configuration information that makes it possible for the mobile device to be configured to work on the network 317, and with other networks the network 317 is interworked with, or communicatively coupled with. The prepaid card 321 is used to provision the services that the customer has purchased, such as DVB-H services, music download services etc. Such provisioning comprises provisioning account information, provisioning, security information, expiry dates, etc. If needed, the customer can simply add more voice talk time or data access time to the prepaid card 321 by purchasing scratch off recharge cards and entering in the recharge code on the handset, or by going to the prepaid customer portal 317 and topping off/recharging the prepaid card 321. In one related embodiment, incoming calls are free, and even if a user has depleted his account balance or credit, the user can still receive voice incoming calls from anywhere in the world, and even have access to some data services. In one related embodiment, a the 4-digit PIN1 code is engraved on the prepaid card 321 that can be used to access the services provided, and can be entered as a password when prompted by the mobile device 307. The PIN1 code is found under the scratch-off protective coating on the prepaid card in another related embodiment.

The prepaid customer portal 317 is used by a customer to setup categories of information that the customer (or a user) is allowed to access using the mobile device 307 with the prepaid card 321. For example, a customer may want to allow only PG13 movies and prevent adult or ‘R-rated’ moves or content (in general) from being accessed by a user of the mobile device 307. The user may be a minor related to the customer. In this scenario, the customer's selections and ‘filters’ for content are stored in the prepaid card 321 after the customer has provided information for content filtering and saved them using the prepaid customer portal 317. Such content screening or content filtering based on customer selections at a portal 317 are aided by the prepaid card 321—such content screening or content filtering information is stored in the prepaid card 321 such that it can be accessed and referred to by appropriate clients in the mobile device 307 during content access or content delivery/rendering in the mobile device 307.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A mobile device capable of communicating with a wireless network using an authentication card, the mobile device comprising:
the authentication card being a pre-paid authentication card;
the mobile device capable of being used for voice communication over the wireless network with a second mobile device using an voice communication authentication information provided by the pre-paid authentication card;
a client application that can be executed on the mobile device;
the client application accessing a service using a configuration information provided by the pre-paid authentication card.

2. The mobile device of claim 1 wherein the pre-paid authentication card is at least one of a SIM card, a SmartCard, a USIM Card and a WIM card, the client application is an email client application and the service is an email service.

3. The mobile device of claim 2 wherein the pre-paid authentication card provides an email user account information and an associated email account password information for use by the email client application to access the email service.

4. The mobile device of claim 3 wherein the configuration information comprises at least one of an incoming email server access information and an outgoing mail server access information.

5. The mobile device of claim 1 further comprising:
the pre-paid authentication card being one of a SIM card, a SmartCard, a USIM Card and a WIM card;
the prepaid authentication card providing a client security information to the client application enabling access to the service via the client application.

6. The mobile device of claim 5 wherein the service is a data service in the wireless network that can be accessed by a user of the mobile device using the client application.

7. The mobile device of claim 6 wherein the client application is a camera application that can be used to take a picture and wherein the data service is a communication service employed by the camera application to upload the picture to a website communicatively coupled to the mobile device.

8. The mobile device of claim 6 wherein the client application is a DVB-H client application that can be used to receive a digital multimedia stream and display it and wherein the service is a DVB-H based multimedia distribution service.

9. The mobile device of claim 8 wherein the wireless network is a WLAN network.

10. The mobile device of claim 9 wherein the wireless network is an interworking combination of a cellular mobile network and a WLAN network.

11. The mobile device of claim 6 wherein the pre-paid authentication card holds at least one of a user's subscription information, mobile device settings and an email settings for a default email account.

12. The mobile device of claim 11 wherein the user can use the default email account to receive and send emails.

13. The mobile device of claim 6 wherein the pre-paid authentication card comprises a mechanism to deduct charges from an associated prepaid amount for the use of the data service.

14. The mobile device of claim 6 wherein the data service is at least one of an email service, an audio download service, a video download service, a streaming media service, a picture upload service, an access to a portal, a push-to-talk service, a VOIP service, an instant messaging service, a game service and an SMS service.

15. The mobile device of claim 14 wherein the pre-paid authentication card can be recharged and wherein the recharging of the pre-paid authentication card before an expiry event associated with the pre-paid authentication card enables the continuation of the data service.

16. A portal used by a customer to top-up a prepaid card that can be used in a mobile device for accessing voice and data services, the portal comprising:
user screens that can be used by the customer to setup access to data services that the user intends to access via the mobile device using the prepaid card;
a prepaid card top-up manager that provides information on an available balance on the prepaid card; and
the prepaid card top-up manager facilitating the recharging of the prepaid card by the customer using the customer's credit card information.

17. The portal in claim 16 that facilitates remote access by the customer to setup access to one or more of the data services using the prepaid card wherein the customer accesses the portal employing one of the mobile device or a personal computer via the Internet.

18. The portal of claim 17 wherein a service access information associated with the services setup by the customer using the portal is communicated to the mobile device over-the-air and saved in the prepaid card.

19. A prepaid access card for accessing voice services comprising:
access information for at least one data service that can be accessed by a mobile device with which the prepaid access card is communicatively coupled;
an account balance that can be deducted when the at least one data service is accessed via the mobile device; and
the account balance capable of being recharged by an over-the-air recharge operation.

20. The prepaid access card of claim 19 wherein the at least one data service is provided to the mobile device over at least one of a cellular wireless network, a WLAN network, a WiMAX network, DVB-H network and an UWB network.
